(19) United States
(12) Patent Application Publication
(10) Pub. No.: US 2019/0001833 A1
(43) Pub. Date: Jan. 3, 2019

(54) METHOD AND SYSTEM FOR VEHICLE-TO-VEHICLE CHARGING

(71) Applicant: Faraday&Future Inc., Gardena, CA (US)

(72) Inventors: Matthew Joseph Coburn, Redondo Beach, CA (US); Skyler Reed Lund, La Crescenta, CA (US)

(21) Appl. No.: 15/691,673

(22) Filed: Aug. 30, 2017

Related U.S. Application Data
(60) Provisional application No. 62/381,993, filed on Aug. 31, 2016.

(51) Int. Cl. B60L 11/18; H02J 7/00

(52) U.S. Cl. CPC B60L 11/1838; B60L 11/1818; B60L 2270/32; B60L 2230/16; H02J 7/0054

(57) ABSTRACT

A vehicle that is capable of vehicle-to-vehicle charging is disclosed. The vehicle may include a processing unit configured to receive a request to charge a first battery of a first vehicle, respond to the request to offer the charge, and authorize the charge. The vehicle may further include a battery configured to charge the first battery.

### CROSS-REFERENCE TO RELATED APPLICATIONS

This application claims the benefit of U.S. Provisional Application No. 62/381,993, filed Aug. 31, 2016, the entirety of which is hereby incorporated by reference.

### TECHNICAL FIELD

The present disclosure relates generally to methods and systems for vehicle charging, and more particularly, to methods and systems for vehicle-to-vehicle charging.

### BACKGROUND

Electric vehicles (EVs) have been gradually replacing existing energy-inefficient vehicles. Consequently, more and more charging stations are built to recharge the EVs. However, situations may still arise where an EV runs out of charge before reaching a charging station. In such circumstances, current solutions are limited to towing the vehicle to a charging station. Such solutions are inefficient and may cost the driver significant time and expense.

### SUMMARY

One aspect of the present disclosure is directed to a vehicle for vehicle-to-vehicle charging. The vehicle may include a processing unit configured to receive a request to charge a first battery of a first vehicle, respond to the request to offer the charge, and authorize the charge. The vehicle may further include a battery configured to charge the first battery. The first vehicle is different from the vehicle.

Another aspect of the present disclosure is directed to a method for vehicle-to-vehicle charging. The method may comprise receiving, by a processing unit of a second vehicle, a request to charge a first battery of a first vehicle, authorizing the charge by the processing unit of the second vehicle, connecting the first battery and a second battery of the second vehicle, and charging the first battery with the second battery.

Another aspect of the present disclosure is directed to a vehicle that receives charges from another vehicle. The vehicle may comprise a battery and a processing unit. The processing unit may be configured to monitor a charge of the battery, generate a request to charge the battery when the charge of the battery is below a threshold, receive location information of multiple vehicles which offer battery power, and select a charging vehicle based on the location information of the multiple vehicles. The vehicle may further include a wireless transmitter configured to transmit the request.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a block diagram illustrating a vehicle-to-vehicle charging system, consistent with exemplary embodiments of the present disclosure.

FIG. 2 is a flowchart illustrating a vehicle-to-vehicle charging method, consistent with exemplary embodiments of the present disclosure.

FIG. 3 is a graphical representation illustrating a vehicle of a vehicle-to-vehicle charging system, consistent with exemplary embodiments of the present disclosure.

FIG. 4 is a graphical representation illustrating vehicle-to-vehicle charging, consistent with exemplary embodiments of the present disclosure.

FIG. 5 is a flowchart illustrating a vehicle-to-vehicle charging method, consistent with exemplary embodiments of the present disclosure.

FIG. 6 is a graphical representation illustrating a vehicle-to-vehicle charging implementation scenario, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current technologies cannot provide flexible and convenient ways to charge stranded-out-of-power EVs. The disclosed systems and methods may mitigate or overcome one or more of the problems set forth above and/or other problems in the prior art. A person having ordinary skill in the art should appreciate that the disclosed systems and methods can also be applied to other vehicles, such as plug-in hybrid vehicles and other chargeable vehicles, and not limited to EVs.

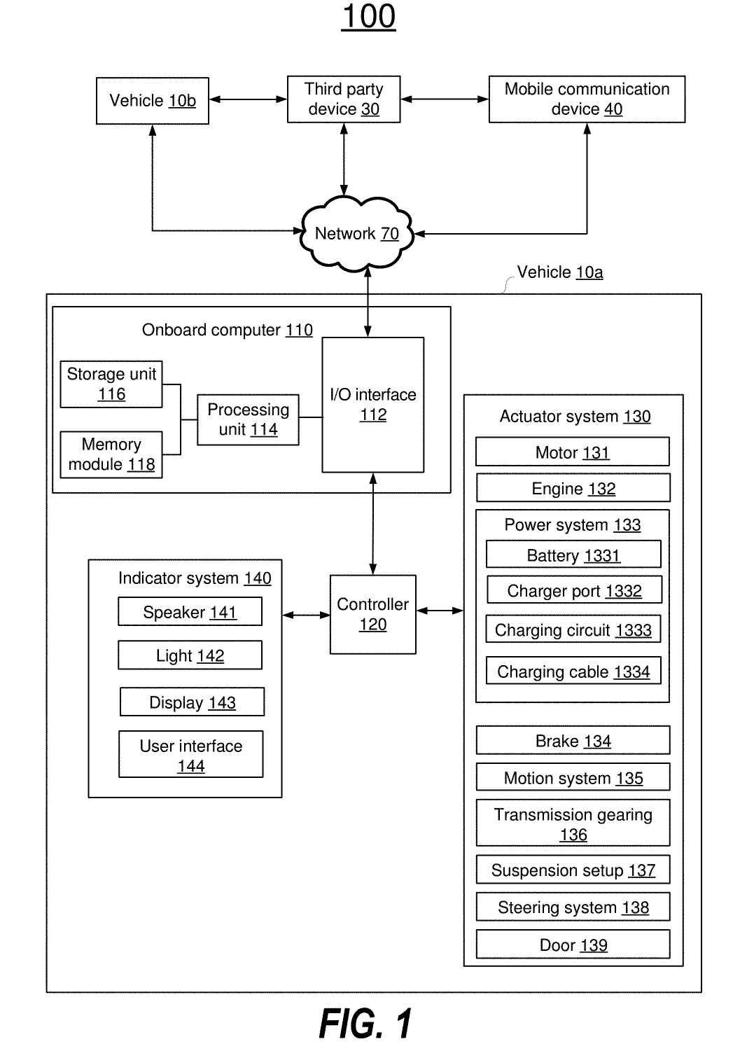

FIG. 1 is a block diagram illustrating a vehicle-to-vehicle charging system 100, consistent with exemplary embodiments of the present disclosure. System 100 may comprise a number of components and sub-components, some of which may be optional. One or more components of system 100 may be configured to perform methods described in this disclosure. However, it is not necessary that all of these components be shown in order to disclose an illustrative embodiment.

As illustrated in FIG. 1, system 100 may include a vehicle 10a and one or more external devices connected via network 70. The external devices may include a vehicle 10b, a third party device 30, and a mobile communication device 40. Network 70 may be optional. For example, vehicles 10a and 10b may not be connected by any network.

Vehicles 10a and 10b may be similar embodiments of vehicle 10. That is, in some embodiments, vehicles 10a and 10b may have similar structures, components and functions. Vehicle 10 may be any type of vehicle, e.g., a vehicle comprising a rechargeable battery and the vehicle being powered by the battery. The vehicle may have any body style of an automobile, such as a sports car, a coupe, a sedan, a pick-up truck, a station wagon, a sports utility vehicle, a minivan, a race car, or a conversion van. The vehicle may also embody other types of transportation, such as motorcycles, boats, buses, trains, and planes. The vehicle may also be a hybrid vehicle, e.g., electric-fuel cell hybrid, electric-combustion hybrid, and etc. The vehicle may be operable by a driver occupying the vehicle, remotely controlled, and/or autonomous. In some embodiments, vehicles 10a and 10b may also have different structures and functions, as long as they each comprise a battery, and one of the batteries is configured to charge the other battery.

Vehicle 10a may include a specialized onboard computer 110, a controller 120, an actuator system 130, and an indicator system 140. Onboard computer 110, actuator system 130, and indicator system 140 may all connect to controller 120. Onboard computer 110 may comprise, among other things, an I/O interface 112, a processing unit/processor 114, a storage unit 116, and a memory module 118, which may transfer data and send or receive instructions among one another. Storage unit 116 and memory module 118 may be non-transitory and computer-readable and may store instructions that, when executed by processing unit 114, cause one or more components of system 100 to perform the methods described in this disclosure. Onboard computer 110 may be specialized to perform the methods and steps described below. One or more of the components of vehicle 10a may be optional. For example, processing unit 114 may directly connect to indicator system 140, bypassing I/O interface 112 and controller 120. Therefore, it is not necessary that all of the above components be shown in order to disclose an illustrative embodiment.

I/O interface 112 may include connectors for wired communications, wireless transmitters and receivers, and/or wireless transceivers for wireless communications. The connectors, transmitters/receivers, or transceivers may be configured for two-way communication between onboard computer 110 and various components of system 100. I/O interface 112 may send and receive operating signals to and from mobile communication device 40 and third party device 30. I/O interface 112 may send and receive the data between each of the devices via communication cables, wireless networks, or other communication mediums. For example, mobile communication device 40 and third party devices 30 may be configured to send and receive signals to I/O interface 112 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Processing unit 114 may include one or more processors, and be configured to receive signals (e.g., sensor signals from indicator system 140, third party device 30, or mobile communication device 40) and process the signals to determine a plurality of conditions of the operation of vehicle 10a (e.g., operations of various components of actuator system 130). Processing unit 114 may also be configured to generate and transmit command signals, via I/O interface 112, in order to actuate other components.

Storage unit 116 and/or memory module 118 may be configured to store one or more computer programs that may be executed by onboard computer 110 to perform functions of vehicle 10a. Storage unit 116 and/or memory module 118 may be configured to store information of various vehicle. Storage unit 116 and/or memory module 118 may be further configured to store data and/or look-up tables used by processing unit 114.

Vehicle 10a may also include a controller 120 connected to onboard computer 110 and capable of controlling one or more aspects of operation of vehicle 10a.

In some examples, controller 120 is connected to one or more actuator systems 130 and one or more indicator systems 140. One or more actuator systems 130 may include, but are not limited to, a motor 131, an engine 132, a power system 133, a brake 134, a motion system 135, a transmission gearing 136, a suspension setup 137, a steering system 138, and one or more doors 139. Some of these components may be optional. For example, an EV may not include engine 132. Onboard computer 110 may control, via controller 120, one or more components of the actuator systems 130 during operation. Power system 133 may include one or more rechargeable batteries 1331, e.g., lithium-ion batteries, a charger port 1332, a charging circuit 1333, and a charging cable 1334, some of which may be optional. Charger port 1332 may be connected to battery 1331. Charger port 1332 may be configured to receive a first end of a pluggable charging cable 1334. Charger port 1332 may include charging circuit 1333 coupled to rechargeable batteries 1331. Charging circuit 1333 may include power regulation circuitry, such as power regulation circuitry employed by power banks, to provide charging current from rechargeable batteries 1331 to a battery to be charged. During a vehicle-to-vehicle charging operation described below, the second end of the charging cable 1334 may be connected to a charging port of vehicle 10b to charge a battery of vehicle 10b. Charging cable 1334 may be disposed inside vehicle 10a or 10b, may be integrated with a vehicle, or may be obtained from elsewhere.

The one or more indicator systems 140 can include, but are not limited to, one or more speakers 141, one or more lights 142, one or more displays 143, and one or more user interfaces 144. Onboard computer 100 can control, via controller 120, one or more of the indicator systems 140 to provide indications of the vehicle, the vehicle's surroundings or another vehicle, to receive instructions, and/or to provide information.

Display 143 may include multiple displays disposed at various locations at vehicle 10a. For example, one display 143 may be mounted on a dashboard in front of a driver seat of vehicle 10a. For another example, one display 143 may be disposed on the vehicle's exterior, e.g., on a B-pillar. Display 143 may be configured to display information related to the vehicle, such as vehicle profile, battery information, access control, and etc. Display 143 may include a touch screen/display that provides an interactive interface.

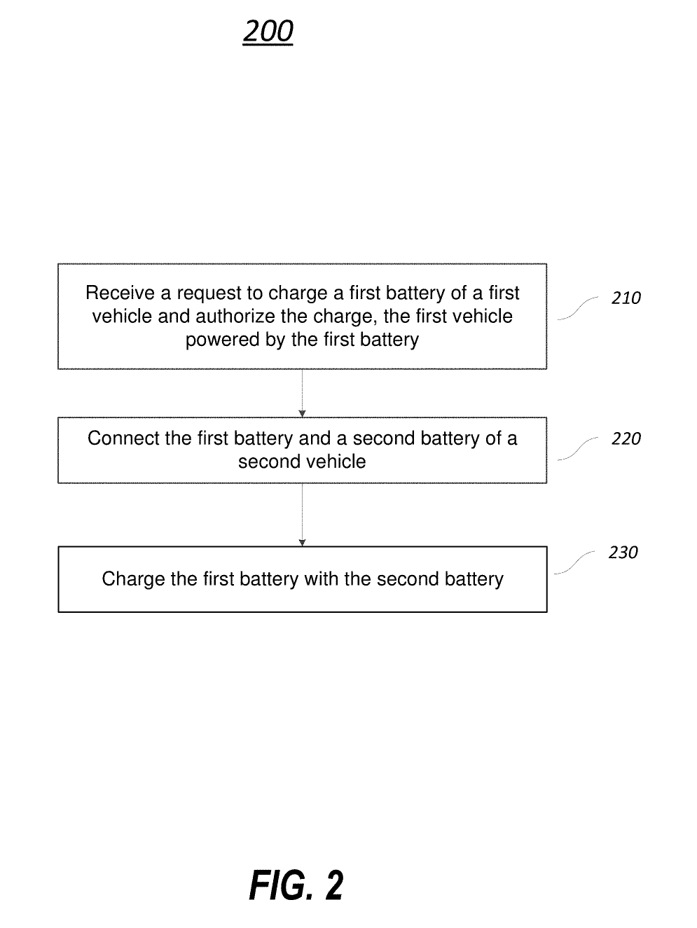

User interface 144 may be configured to receive inputs from users or devices and to transmit data. For example, user interface 144 may be implemented with a display 143 including an LCD, an LED, a plasma display, or any other type of display, and provide a graphical user interface (GUI) presented on the display for user input and data display. User interface 144 may further include speakers or other voice playing devices. User interface 144 may further include input devices, such as a touchscreen, a keyboard, a mouse, a microphone, and/or a tracker ball, to receive a user input. User interface 144 may also connect to a network to remotely receive instructions or user inputs. Thus, the input may be directly entered by a user, captured by user interface 144, or received by user interface 144 over the network. In some embodiments, the user input may be a request to perform a vehicle-to-vehicle charging, and the request may be received via user interface 144, third party device 30, mobile communication device 40, vehicle 10a or 10b, or a combination thereof. Responding to the command, vehicle 10 or an associated user may perform the charging task, e.g., by performing method 200 described below with reference to FIG. 2.

User interface 144 may also be configured to receive user-defined settings. For example, user interface 144 may be configured to receive user profiles including, for example, an age, a gender, a driving license status, frequent destinations, vehicle charging frequencies, vehicle charging stations, and etc. In some embodiments, user interface 144 may include a touch-sensitive surface configured to receive biometric data (e.g., detect a fingerprint of a user). The touch-sensitive surface may be configured to detect the ridges and furrows of a fingerprint based on a change in capacitance and generate a signal based on the detected fingerprint, which may be processed by processing unit 114. Processing unit 114 may be configured to compare the signal with stored data to determine whether the fingerprint matches recognized users. Vehicle 10 may also be able to connect to the Internet, obtain data from the Internet, and compare the signal with obtained data to identify the users. User interface 144 may be configured to include biometric data into a signal, such that processing unit 114 can identify the person generating the input. User interface 144 may also compare a received voice input with stored voices to identify the person generating the input. Furthermore, user interface 144 may be configured to store data history accessed by the identified person. Based on the identities, processing unit 114 may grant or decline access to use one or more batteries associated with the vehicle.

In some embodiments, user interface 144 may include one or more electrophysiological sensors for encephalography-based autonomous driving. For example, an electrophysiological sensor may detect electrical activities of brains of the user(s) and convert the electrical activities to signals, such that processing unit 114 can execute a corresponding command, such as charging a battery.

Through I/O interface 112, vehicle 10a may be in communication with a plurality of devices, such as third party device 30, mobile communication device 40, and vehicle 10b. Mobile communication device 40 may include a smart phone, a tablet, a personal computer, a wearable device, such as a smart watch or Google Glass™, and/or complimentary components. Mobile communication device 40 may be configured to connect to a network, such as a nationwide cellular network, a local wireless network (e.g., Bluetooth™ or WiFi), and/or a wired network. Mobile communication device 40 may also be configured to access apps and websites of third parties, such as iTunes™, Google™, Facebook™, Yelp™, or other apps and websites associated with vehicle 10. Vehicle 10, third party device 30, and mobile communication device 40 may store and share data and information, such as a profile of vehicle 10 (e.g., the year, make, model, and owner of a vehicle) and information of power system 133 (e.g., the location of charger port 1332 on vehicle 10a and the remaining power in battery 1331).

In some embodiments, mobile communication device 40 may be carried by or associated with one or more users of vehicle 10. For example, vehicle 10 may be configured to determine the identity of a user based on a digital signature or other identification information from mobile communication device 40. For instance, processing unit 110 of vehicle 10a may be configured to relate the digital signature to stored profile data including the person's name and the person's relationship with vehicle 10a. The digital signature of mobile communication device 40 may include a determinative emitted radio frequency (RF) or a global positioning system (GPS) tag. Mobile communication device 40 may be configured to automatically connect to or be detected by vehicle 10 through local network 70.

Third party device 30 may include smart phones, personal computers, laptops, pads, servers, and/or processors of third parties. Third party devices 30 may be accessible to the users through mobile communication device 40 or directly accessible by vehicle 10a via network 70. In some embodiments, vehicle 10b may transmit a request to vehicle 10a directly or through third party device 30 or mobile communication device 40. Vehicle 10a may receive the request. The request may be related to charging a battery of vehicle 10b. In some embodiments, vehicle 10a may obtain information of vehicle 10b, such as vehicle profiles, from vehicle 10b, third party device 30, and/or mobile communication device 40. The information may also include, for example, a charger port location the vehicle, a battery capacity of the vehicle, a battery model, and etc.

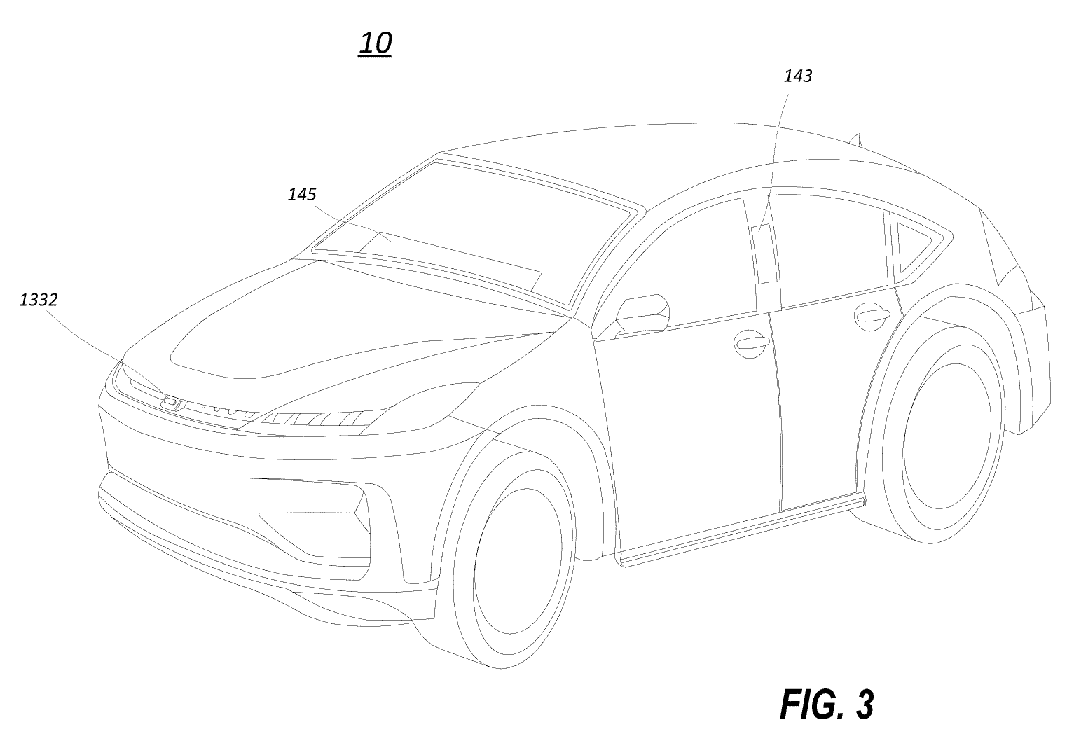

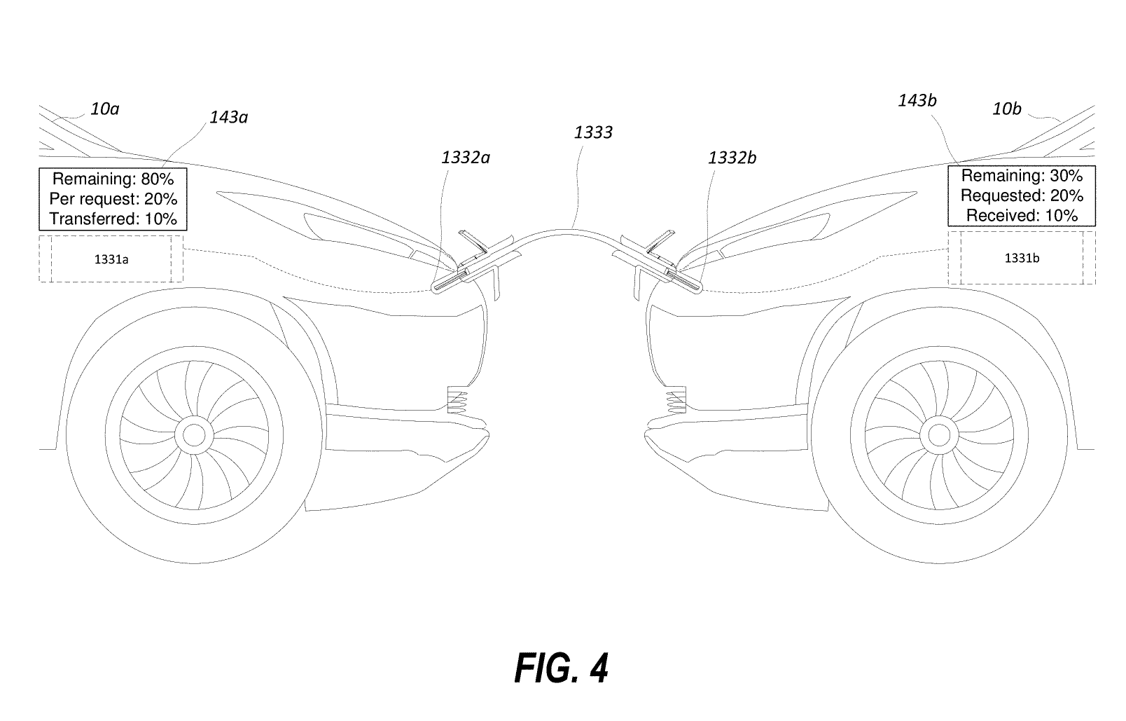

FIG. 2 is a flowchart illustrating a vehicle-to-vehicle method 200, consistent with exemplary embodiments of the present disclosure. Method 200 may describe the vehicle-to-vehicle charging method from a perspective of a user or vehicle receiving the request for vehicle-to-vehicle charging. Method 200 may include a number of steps and sub-steps, some of which may be optional. The steps or sub-steps may also be rearranged in another order. Some of the steps of method 200 may be related to FIG. 3 and FIG. 4, which are graphical illustrations consistent with exemplary embodiments of the present disclosure.

In Step 210, one or more components of system 100 may receive a request to charge a first battery of a first vehicle and authorize the charge, the first vehicle powered by the first battery. For example, vehicle 10a or a user associated with vehicle 10a may receive the request from vehicle 10b or a user associated with vehicle 10b (here, vehicle 10b may be the first vehicle).

An exemplary vehicle 10 is shown in FIG. 3. Vehicle 10 may be an electric vehicle, or a hybrid vehicle. As illustrated in FIG. 3, vehicle 10 may comprise a charger port 1332 disposed at the vehicle front between a hood and a bumper, a display 143 disposed on a B-pillar of the vehicle, and a user interface 144 projected from a dashboard of the vehicle. The charger port 1332 may be connected to a battery that powers vehicle 10. Alternatively, the above components of the vehicle may be disposed at other positions.

In some embodiments, processing unit 114 may receive the request to charge the first battery of the first vehicle. As described above with reference to FIG. 1, the request may be transmitted via a direct user input, or via a network from the first vehicle, a third party device associated with the first vehicle, or a mobile communication device associated with the first vehicle. For example, a driver of the first vehicle may transmit the request using a user interface of the first vehicle or a mobile phone carried by the driver. In some embodiments, the I/O interface 112 may include wireless transmitter/receiver or transceiver that can receive the request wirelessly, and send the request to processing unit. The request may comprise information of the first vehicle, such as the vehicle model, the battery model associated with the vehicle, the battery-charging compatibility, a requested amount of charge (e.g., 3 kW), offered compensation, and the like. Processing unit 114 may receive the request and cause user interface 144 to display relevant information, for example, options to accept or decline the request. Alternatively, the request may be received by another component of or another device associated with vehicle 10a. After receiving the request, vehicle 10a, e.g., processing unit 114, or a user associated with vehicle 10a may authorize, ignore, or decline the charge. By authorizing the charge, processing unit 114 may, for example, open charger port 1332 for charger cable connection described above. Processing unit 114 may limit an amount of power transfer from the battery of vehicle 10a to the battery of vehicle 10b.

In some embodiments, the request may be broadcast, for example, in a form of a “SOS signal” when the power level is dangerously low, and the request may be picked up by a second vehicle. Alternatively, the request may be transmitted specifically to a vehicle or device. For example, the first vehicle may approach a parked second vehicle, detect an owner of the second vehicle through an onboard computer, and transmit the request to a mobile communication device of the owner of the second vehicle. The request may comprise a compensation for the power transfer request, such as a fee payment. The owner of the second vehicle may remotely authorize the power transfer. With the authorization, the second vehicle may allow access to its charger port, for example, when the first vehicle is in proximity. The owner of the second vehicle may transmit, via a mobile device, or the second vehicle may transmit, a passcode to the first vehicle, and the passcode can be used to open the charger port on the second vehicle. That is, the passcode may grant access to the second battery.

In Step 220, one or more components of system 100 may connect the first battery and a second battery of a second vehicle. The second vehicle may or may not be powered by the second battery. For example, the second battery may be a battery powering an electric vehicle, or may be a mobile battery unit stored on a vehicle. There may be many methods to connect the batteries. For example, vehicle 10a, as the second vehicle, may comprise a charging cable with a first end connected to a charger port of vehicle 10a, and vehicle 10a may extend the charging cable to connect a second end of the charging cable to a charger port of vehicle 10b (here, vehicle 10b may be the first vehicle). For another example, a user associated with vehicle 10a or 10b may plug a first end of a charging cable to a charger port of vehicle 10a and plug a second end of the charging cable to a charger port of vehicle 10b. The charging cable may be similar to charging cable 1334 described above. The charger port may be similar to charger port 1332 described above.

In Step 230, one or more components of system 100 may charge the first battery with the second battery. For example, vehicle 10a may charge vehicle 10b's battery by its battery via the charging cable.

Referring to FIG. 4, vehicle 10a and vehicle 10b may be similar electric cars. Vehicle 10a may comprise a charger port 1332a, a battery 1331a, and a display 143a. Vehicle 10b may comprise a charger port 1332b, a battery 1331b, and a display 143b. The charger port may be connected to the battery respectively. The display may be disposed on a side surface of the vehicle, at a B-pillar position, or at other positions respectively.

As shown in FIG. 4, vehicle 10a and vehicle 10b are connected by charging cable 1334. Charging cable 1334 may have any length. Charging cable 1334 may be pluggable on one end or both ends. Charging cable 1334 may also comprise a motor and associated mechanics configured to extend charging cable 1334 to connect to a charging port. Charging cable 1334 may be uni-directional or bi-directional with respect to current flow.

As shown in FIG. 4, display 143a and/or display 143b may display information related to the vehicle-to-vehicle charging. Displays 143a and 143b may be installed on B-pillars of vehicles 10a and 10b. For example, display 143a may display that 80% of the battery capacity of 1331a is remaining, vehicle 10b has requested power equivalent to 20% of 1331a's capacity from vehicle 10a, and power equivalent to 10% of 1331a's capacity has been transferred to vehicle 10b. Display 143b may display that 30% of the battery capacity of 1331b is remaining, vehicle 10b has requested power equivalent to 20% of 1331a's capacity from vehicle 10a, and power equivalent to 10% of 1331a's capacity has been transferred to vehicle 10b. The displayed information may be presented in another unit such as kW or may include other information. The charging process can be monitored or controlled through various devices, such as displays 143 (a or b), user interface 144, third party device 30, and/or mobile communication device 40 on either vehicle.

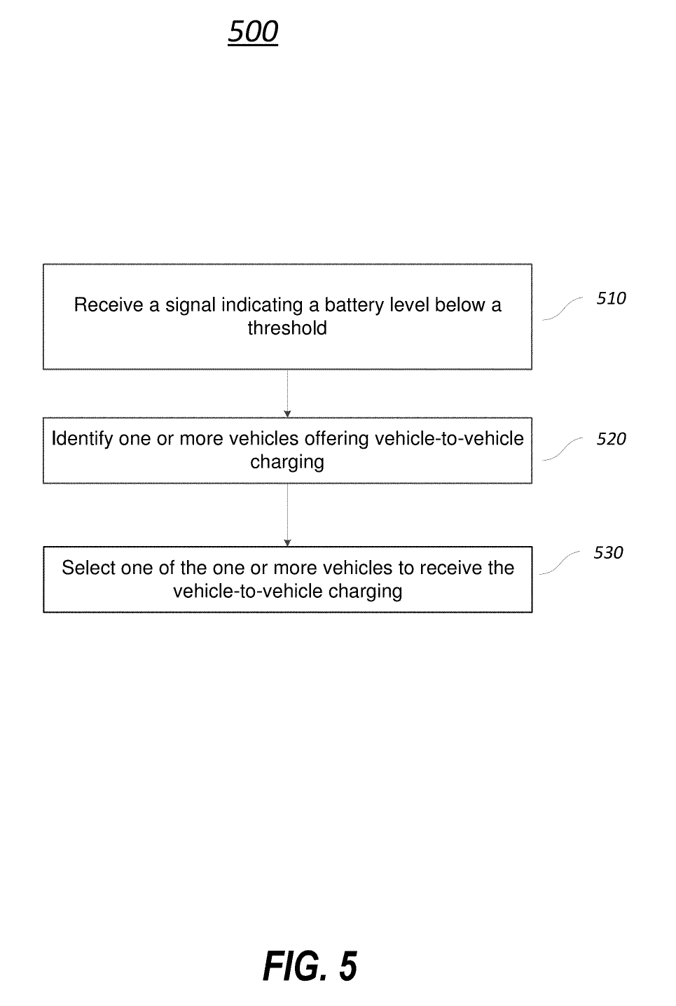

FIG. 5 is a flowchart illustrating a vehicle-to-vehicle method 500, consistent with exemplary embodiments of the present disclosure. Method 500 may describe the vehicle-to-vehicle charging method from a perspective of a user or vehicle transmitting a request for the vehicle-to-vehicle charging. Method 500 may comprise one or more steps, some of which may be optional or rearranged in another order.

At step 510, one or more components of a first vehicle may receive a signal indicating a battery level below a threshold. For example, the processor of the first vehicle may receive a signal indicating the battery capacity, and determine that the battery level of the first battery of the first vehicle is below 10% or inadequate to reach a destination. The processor may generate a request to charge the battery when the charge of the battery is below a threshold. In some embodiments, the method may further include transmitting or broadcasting, by a transmitter or transceiver, the request to charge the first battery.

At step 520, one or more components of the first vehicle may identify one or more vehicles offering vehicle-to-vehicle charging. For example, the processor of the first vehicle may broadcast or specifically transmit a request for vehicle-to-vehicle charging as described herein to one or more other vehicles or devices. The processor may receive one or more responses, such as offers to charge the first battery. In some other embodiments, the vehicles that offer power may broadcast signals including information on its availability and its location. The first vehicle may also identify charging stations on a map stored on the first vehicle.

At step 530, one or more components of the first vehicle may select one of the one or more vehicles to receive the vehicle-to-vehicle charging. For example, the processor may select one of the offers from a second vehicle based on factors, like proximity, cost, and/or other factors, and send back an acknowledgement to the second vehicle. The two vehicles can thus meet and perform the vehicle-to-vehicle charging. If the second vehicle is not operated by anyone in proximity, an associated owner of the second vehicle may transmit a passcode to the first vehicle, so that the first vehicle may access the battery of the second vehicle by inputting the passcode to the second vehicle to unlock a charger port. The first vehicle may transmit the passcode to the second vehicle's on-board computer wirelessly, e.g., via Bluetooth, when the first vehicle is close to the second vehicle. In another embodiment, the user of the first vehicle may input the passcode on a touch screen/display installed on an exterior surface of the second vehicle, e.g., the outside of the B-pillar or other parts of the second vehicle. The methods disclosed herein can be modified or combined with any embodiment of this disclosure.

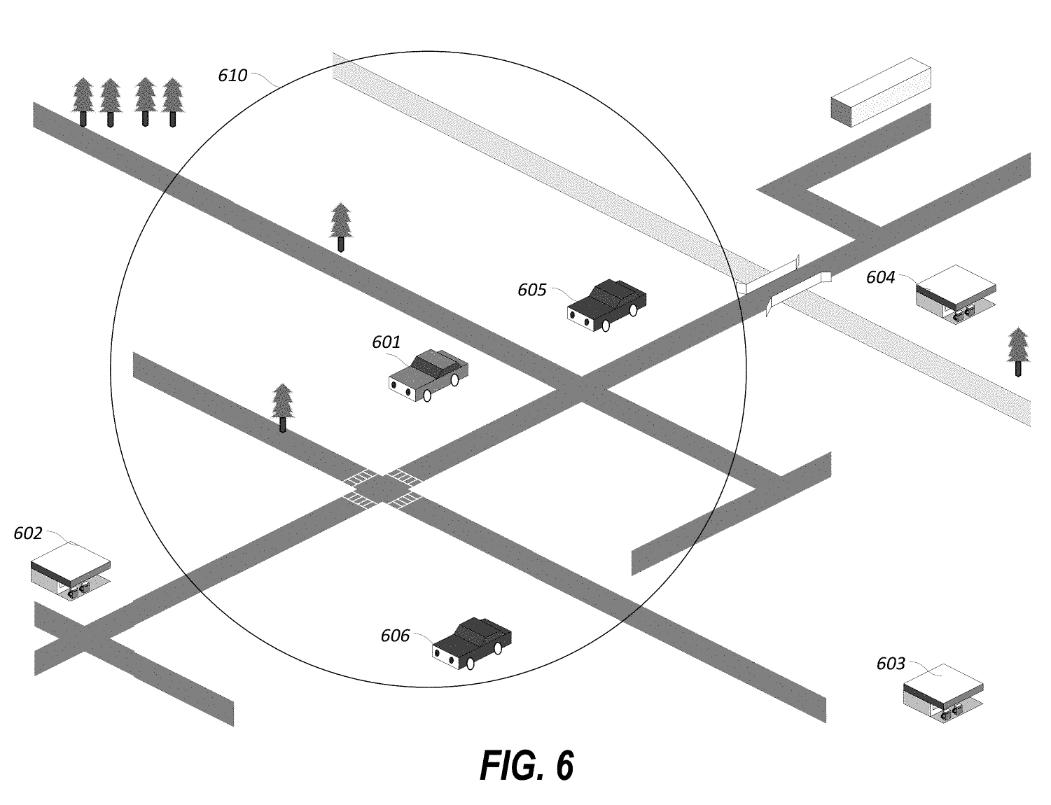

FIG. 6 is a graphical representation illustrating a vehicle-to-vehicle charging implementation scenario, consistent with exemplary embodiments of the present disclosure. As shown in a map view of FIG. 6, vehicles 601, 605, and 606 and charging stations 602, 603, and 604 are located in a certain community. In this example, the vehicles are electric vehicles, and the charging stations are equipped with EV chargers. At one point of time, vehicle 601, e.g., its processor, or a driver of vehicle 601 may determine that vehicle 601 is low on power, and in response, start searching for a power recharge source. The processor of vehicle 601 may determine, based on a remaining power level and a power consumption rate, past power consumption history, or the like, a maximum distance that vehicle 601 can travel before consuming all battery power. The processor of vehicle 601 may display a map as shown in or similar to FIG. 6 on an associated user interface, indicating information such as positions of vehicle 601 itself, nearest charging stations (e.g., charging stations 602-604), and/or nearest EVs (e.g., vehicles 605 and 606) that offer battery power to other EVs. The maximum distance may be represented by circle 610 with vehicle 601 at its center, indicating that places outside the circle, such as all the nearest charging stations, may not be reachable with the remaining power. In this situation, the driver or the processor of vehicle 601 may transmit or broadcast a request for vehicle-to-vehicle charging as described above with reference to FIG. 2. The request may comprise a compensation for a certain amount of power to charge vehicle 601's battery. Vehicles 605, 606, and/or other vehicles or devices may receive the request. For example, an user interface of vehicle 605 may receive the request and display information such as a request for vehicle-to-vehicle charging originated from vehicle 601, and a relative position between vehicle 601 and vehicle 605. Alternatively, vehicle 605 may be parked and may relay the request to a mobile phone of an owner of vehicle 605, who may be away from vehicle 605. Or, the mobile phone may directly receive the request. In any case, the user or owner may accept, ignore, or decline the request. If the user of vehicle 605 accepts the request and transmits an acknowledgement to vehicle 601, the two vehicles may meet and perform vehicle-to-vehicle charging described above. If the owner of vehicle 605 accepts the request while being away from vehicle 605, the owner may remotely authorize access to vehicle 605's battery, for example, by sending over a passcode for opening the charger port on vehicle 605. The driver of vehicle 601 may then drive to the parked vehicle 605, input the passcode, e.g., on a display mounted on vehicle 605's B-pillar, to access vehicle 605's charger port and battery for vehicle-to-vehicle charging. Alternatively, vehicle 605 may drive to vehicle 601 to offer battery power to vehicle 601.

As described above, vehicles, users, charging stations, and other devices may form a sharing community by sharing each other's information and requests, such as vehicle location, battery capacity, power for transfer, offer price, and etc. Such information or requests can be presented in many forms, such as maps or radio messages. Any person or vehicle requiring or offering a service can upload or search for related information, and choose from the choices available. For example, a vehicle requesting vehicle-to-vehicle charging may receive multiple offers and may choose a charging vehicle based on the location of the vehicles which offer battery power. For example, the vehicle requesting charging may choose a charging vehicle on its route to a destination. The vehicle requesting charging may choose a charging vehicle based on other factors, such as cost (e.g., the cheapest offer), distance (e.g., the closest-in-distance offer), or another offer based on an alternative criterion. Similarly, a vehicle offering vehicle-to-vehicle charging may authorize access based on one or more criteria. In some embodiments, an owner of the second vehicle, e.g. vehicle 605 and vehicle 606, may determine and offer an amount of power of the vehicle battery for transfer, for example, by broadcasting an sale of EV power or offering for free. Another vehicle or vehicle owner may receive and accept the offer to recharge an associated battery. A processing unit of the second vehicle may be configured to limit an amount of power transfer from the its battery to another battery. A vehicle participating the sharing community may see the location of other vehicles that offer or need battery power on a map as shown in FIG. 6. In some embodiments, a user may choose whether it wants other vehicles to detect its location. In some other embodiments, the visibility of the location of other vehicles may be limited by distance. For example, a vehicle may be able to detect the location of other vehicles in the sharing community which is within a certain mileages. For the example described above with connection to FIG. 6, in some embodiments, vehicle 601 that needs power may be able to see the location of other vehicles, e.g., vehicles 605 and 606 which offer power, without broadcasting request. The existing technologies, such as using GPS, cellular network, WiFi network, and/or other technologies to determine the location of a vehicle which is equipped with GPS transceiver and/or connected to cellular and/or WiFi network can be used. A server can be used to collect the location information of the vehicles and present it to the vehicle in need of such information. The above described vehicle information and vehicle owners' information may also be saved on the server and provided by the server.

As described above, vehicle batteries can be charged by batteries of other vehicles, which can be more accessible than charging stations. With the disclosed system and methods, electric vehicle owners may no longer need to worry about running out of power, since other vehicles in nearby or other locations can become power reserve supplies.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable storage medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for vehicle-to-vehicle charging. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A vehicle, comprising:
a processing unit configured to:
receive a request to charge a first battery of a first vehicle different from the vehicle;
respond to the request to offer the charge; and
authorize the charge; and
a battery configured to charge the first battery.

2. The vehicle of claim 1, wherein the request comprises an amount of power requested by the first vehicle.

3. The vehicle of claim 1, further comprising a charging circuit coupled to the battery to provide charging to the first battery.

4. The vehicle of claim 1, wherein the processing unit is configured to limit an amount of power transfer from the battery to the first battery.

5. The vehicle of claim 1, further comprising a touch display on an exterior surface of the vehicle and coupled to the processing unit, wherein the touch display is configured to receive an input passcode, and the processing unit is configured to authorize the charge based on the passcode.

6. The vehicle of claim 1, wherein the touch display is on a B-pillar of the vehicle.

7. The vehicle of claim 1, further comprising a wireless receiver coupled to the processing unit, the wireless receiver being configured to receive the request wirelessly and send the request to the processing unit.

8. A method for vehicle-to-vehicle charging, the method comprising:
receiving, by a processing unit of a second vehicle, a request to charge a first battery of a first vehicle;
authorizing the charge by the processing unit of the second vehicle;
connecting the first battery and a second battery of the second vehicle; and
charging the first battery with the second battery.

9. The method of claim 8, wherein the request comprises an amount of power transfer to the first battery.

10. The method of claim 8, wherein authorizing the charge comprises authorizing an amount of power transfer from the second battery to the first battery.

11. The method of claim 8, further comprising receiving a passcode, wherein authorizing the charge is based on the received passcode.

12. The method of claim 11, wherein receiving the passcode comprises receiving the passcode wirelessly.

13. The method of claim 11, wherein receiving the passcode comprises receiving the passcode via a touch display on an exterior surface of the vehicle.

14. The method of claim 13, wherein the touch display is on a B-pillar of the second vehicle.

15. A vehicle comprising:
a battery;
a processing unit configured to:
monitor a charge of the battery;
generate a request to charge the battery when the charge of the battery is below a threshold;
receive location information of multiple vehicles which offer battery power; and
select a charging vehicle based on the location information of the multiple vehicles; and
a wireless transmitter configured to transmit the request.

16. The vehicle of claim 15, wherein to select a charging vehicle based on the location information of the multiple vehicles from the vehicle, the processing unit is further configured to:
select a charging vehicle based on distance of the multiple vehicles from the vehicle.

17. The vehicle of claim 15, wherein the wireless transmitter is further configured to transmit a passcode to a charging vehicle for obtaining authorization of charging the battery from a charging battery of the charging vehicle.

18. The vehicle of claim 15, further comprising a wireless receiver configured to receive a passcode for obtaining authorization of charging the battery from a charging battery of a charging vehicle.

19. The vehicle of claim 15, wherein the processing unit is further configured to:
receive one or more responses from one or more charging vehicles indicating to offer battery power to the vehicle; and
select a charging vehicle based on distance of the one or more charging vehicles from the vehicle.

20. The vehicle of claim 19, wherein the processing unit is further configured to select a charging vehicle further based on cost.
